(19) United States
(12) Patent Application Publication
(10) Pub. No.: US 2009/0282211 A1
(43) Pub. Date: Nov. 12, 2009

(54) Network On Chip With Partitions

(75) Inventors: Russell D. Hoover, Rochester, MN (US); Eric O. Mejdrich, Rochester, MN (US); Paul E. Schardt, Rochester, MN (US); Robert A. Shearer, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES, ARMONK, NY (US)

(21) Appl. No.: 12/117,906

(22) Filed: May 9, 2008

(51) Int. Cl. G06F 12/02

(52) U.S. Cl. 711/173; 711/E12.002

(57) ABSTRACT

Data processing with a network on chip (‘NOC’) that includes integrated processor (‘IP’) blocks, routers, memory communications controllers, and network interface controller, including: organizing the network into partitions; assigning all IP blocks of a partition a partition identifier (‘partition ID’) that uniquely identifies for an IP block a particular partition in which the IP block is included; establishing one or more permissions tables associating partition IDs with sources and destinations of data communications on the NOC, each record in the permissions tables representing a restriction on data communications on the NOC; executing one or more applications on one or more of the partitions, including transmitting data communications messages among IP blocks and between IP blocks and memory, each data communications message including a partition ID of a sender of the data communications message; and controlling data communications among the partitions in dependence upon the permissions tables and the partition IDs.

### BACKGROUND OF THE INVENTION

1. Field of the Invention

The field of the invention is data processing, or, more specifically apparatus and methods for data processing with a network on chip (‘NOC’).

2. Description of Related Art

There are two widely used paradigms of data processing; multiple instructions, multiple data (‘MIMD’) and single instruction, multiple data (‘SIMD’). In MIMD processing, a computer program is typically characterized as one or more threads of execution operating more or less independently, each requiring fast random access to large quantities of shared memory. MIMD is a data processing paradigm optimized for the particular classes of programs that fit it, including, for example, word processors, spreadsheets, database managers, many forms of telecommunications such as browsers, for example, and so on.

SIMD is characterized by a single program running simultaneously in parallel on many processors, each instance of the program operating in the same way but on separate items of data. SIMD is a data processing paradigm that is optimized for the particular classes of applications that fit it, including, for example, many forms of digital signal processing, vector processing, and so on.

There is another class of applications, however, including many real-world simulation programs, for example, for which neither pure SIMD nor pure MIMD data processing is optimized. That class of applications includes applications that benefit from parallel processing and also require fast random access to shared memory. For that class of programs, a pure MIMD system will not provide a high degree of parallelism and a pure SIMD system will not provide fast random access to main memory stores.

### SUMMARY OF THE INVENTION

Methods and apparatus for data processing with a network on chip (‘NOC’) that includes integrated processor (‘IP’) blocks, routers, memory communications controllers, and network interface controller, with each IP block adapted to a router through a memory communications controller and a network interface controller, where data processing with a NOC in accordance with embodiments of the present invention includes: organizing the network into partitions, each partition including at least one IP block, each partition assigned exclusive access to a separate physical memory address space; assigning all IP blocks of a partition a partition identifier (‘partition ID’) that uniquely identifies for an IP block a particular partition in which the IP block is included; establishing one or more permissions tables associating partition IDs with sources and destinations of data communications on the NOC, each record in the permissions tables representing a restriction on data communications on the NOC; executing one or more applications on one or more of the partitions, including transmitting data communications messages among IP blocks and between IP blocks and memory, each data communications message including a partition ID of a sender of the data communications message; and controlling data communications among the partitions in dependence upon the permissions tables and the partition IDs.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in data processing with a NOC according to embodiments of the present invention.

FIG. 2 sets forth a functional block diagram of an example NOC according to embodiments of the present invention.

FIG. 3 sets forth a functional block diagram of a further example NOC according to embodiments of the present invention.

FIG. 4 sets forth a flow chart illustrating an exemplary method for data processing with a NOC according to embodiments of the present invention.

FIG. 5 sets forth a functional block diagram of a further example NOC according to embodiments of the present invention.

FIG. 6 sets forth a data flow diagram illustrating operation of an example pipeline.

FIG. 7 sets forth a flow chart illustrating an exemplary method for data processing with a NOC according to embodiments of the present invention.

### DETAILED DESCRIPTION OF EXEMPLARY EMBODIMENTS

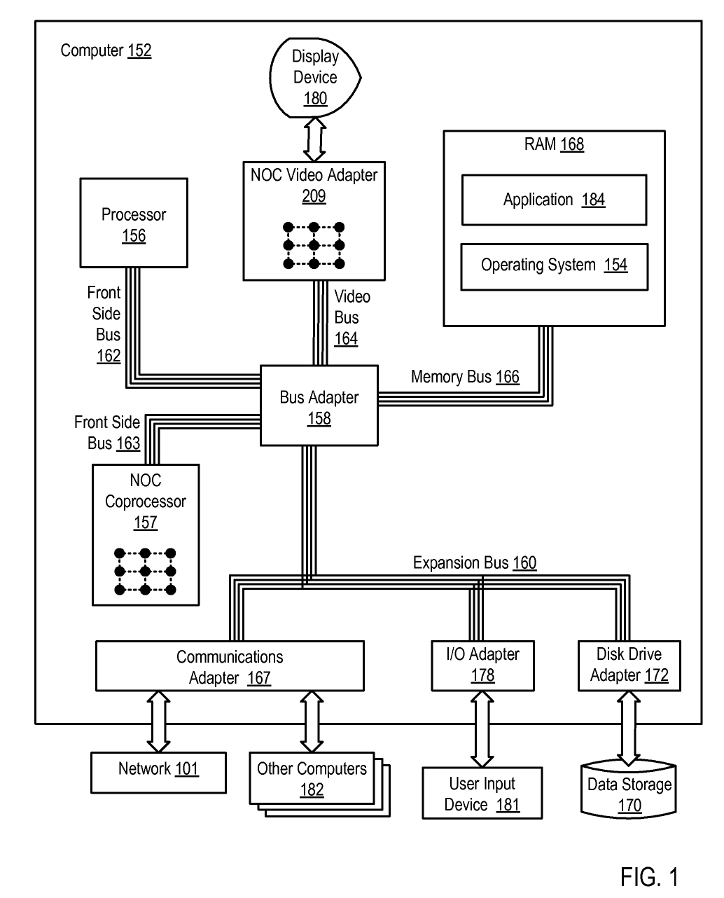

Exemplary apparatus and methods for data processing with a NOC in accordance with the present invention are described with reference to the accompanying drawings, beginning with FIG. 1. FIG. 1 sets forth a block diagram of automated computing machinery comprising an exemplary computer (152) useful in data processing with a NOC according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152). Stored in RAM (168) is an application program (184), a module of user-level computer program instructions for carrying out particular data processing tasks such as, for example, word processing, spreadsheets, database operations, video gaming, stock market simulations, atomic quantum process simulations, or other user-level applications. Also stored in RAM (168) is an operating system (154). Operating systems useful data processing with a NOC according to embodiments of the present invention include UNIX™, Linux™, Microsoft XP™, AIX™, IBM's i5/OS™, and others as will occur to those of skill in the art. The operating system (154) and the application (184) in the example of FIG. 1 are shown in RAM (168), but many components of such software typically are stored in non-volatile memory also, such as, for example, on a disk drive (170).

The example computer (152) includes two example NOCs according to embodiments of the present invention: a video adapter (209) and a coprocessor (157). The video adapter (209) is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

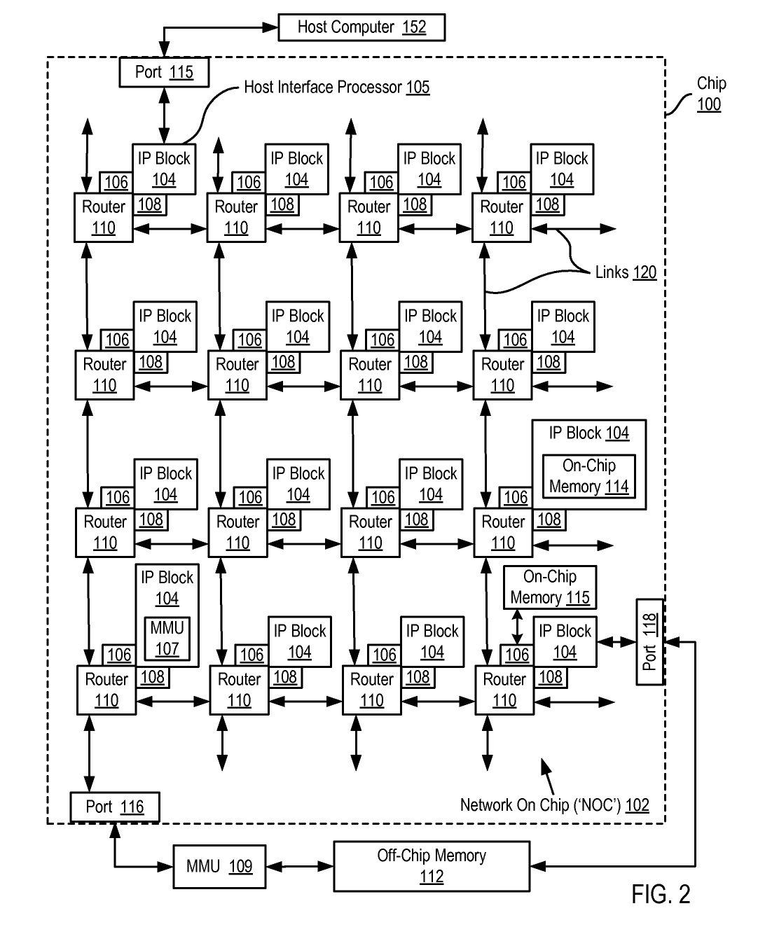

The example NOC coprocessor (157) is connected to processor (156) through bus adapter (158), and front side buses (162 and 163), which is also a high speed bus. The NOC coprocessor of FIG. 1 is optimized to accelerate particular data processing tasks at the behest of the main processor (156). The NOC video adapter and the NOC coprocessor are optimized for programs that use parallel processing and also require fast random access to shared memory. The details of the NOC structure and operation are discussed below with reference to FIGS. 2-4.

The example NOC video adapter (209) and NOC coprocessor (157) of FIG. 1 each include a NOC according to embodiments of the present invention, including integrated processor (‘IP’) blocks, routers, memory communications controllers, and network interface controllers, each IP block adapted to a router through a memory communications controller and a network interface controller, each memory communications controller controlling communication between an IP block and memory, and each network interface controller controlling inter-IP block communications through routers. The networks of the NOC video adapter (209) and NOC coprocessor (157) are organized into partitions with each partition including at least one IP block and each partition assigned exclusive access to a separate physical memory address space. All IP blocks of a partition are assigned a partition identifier (‘partition ID’) that uniquely identifies for an IP block a particular partition in which the IP block is included. The NOC video adapter (209) and NOC coprocessor (157) may also include one or more permissions tables associating partition IDs with sources and destinations of data communications on the NOC are established on the NOC with each record in the permissions tables representing a restriction on data communications on the NOC. The NOC video adapter (209) and NOC coprocessor (157) may also include one or more applications executing on one or more of the partitions, including transmitting data communications messages among IP blocks and between IP blocks and memory with each data communications message including a partition ID of a sender of the data communications message. Data communications among the partitions in the example NOC video adapter (209) and NOC coprocessor (157) may be controlled in dependence upon the permissions tables and the partition IDs. The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for data processing with a NOC according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art. The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for data processing with a NOC according to embodiments of the present invention include modems for wired dial-up communications, Ethernet (IEEE 802.3) adapters for wired data communications network communications, and 802.11 adapters for wireless data communications network communications.

For further explanation, FIG. 2 sets forth a functional block diagram of an example NOC (102) according to embodiments of the present invention. The NOC in the example of FIG. 2 is implemented on a ‘chip’ (100), that is, on an integrated circuit. The NOC (102) of FIG. 2 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110). In addition, the example NOC (102) of FIG. 2 also includes the network organized into partitions where each partition includes at least one IP block (104) and each partition is assigned exclusive access to a separate physical memory address space. All IP blocks of a partition in the example NOC of FIG. 2 are assigned a partition identifier (‘partition ID’) that uniquely identifies for an IP block a particular partition in which the IP block is included. The example NOC also includes one or more permissions tables associating partition IDs with sources and destinations of data communications on the NOC established on the NOC where each record in the permissions tables represents a restriction on data communications on the NOC. The example NOC also includes one or more applications executing on one or more of the partitions, including transmitting data communications messages among IP blocks and between IP blocks and memory with each data communications message including a partition ID of a sender of the data communications message. Data communications among the partitions in the NOC (102) of FIG. 2 may be controlled in dependence upon the permissions tables and the partition IDs.

In the NOC (102) of FIG. 2, each IP block represents a reusable unit of synchronous or asynchronous logic design used as a building block for data processing within the NOC. The term ‘IP block’ is sometimes expanded as ‘intellectual property block,’ effectively designating an IP block as a design that is owned by a party, that is the intellectual property of a party, to be licensed to other users or designers of semiconductor circuits. In the scope of the present invention, however, there is no requirement that IP blocks be subject to any particular ownership, so the term is always expanded in this specification as ‘integrated processor block.’ IP blocks, as specified here, are reusable units of logic, cell, or chip layout design that may or may not be the subject of intellectual property. IP blocks are logic cores that can be formed as ASIC chip designs or FPGA logic designs.

One way to describe IP blocks by analogy is that IP blocks are for NOC design what a library is for computer programming or a discrete integrated circuit component is for printed circuit board design. In NOCs according to embodiments of the present invention, IP blocks may be implemented as generic gate netlists, as complete special purpose or general purpose microprocessors, or in other ways as may occur to those of skill in the art. A netlist is a Boolean-algebra representation (gates, standard cells) of an IP block's logical-function, analogous to an assembly-code listing for a high-level program application. NOCs also may be implemented, for example, in synthesizable form, described in a hardware description language such as Verilog or VHDL. In addition to netlist and synthesizable implementation, NOCs also may be delivered in lower-level, physical descriptions. Analog IP block elements such as SERDES, PLL, DAC, ADC, and so on, may be distributed in a transistor-layout format such as GDSII. Digital elements of IP blocks are sometimes offered in layout format as well.

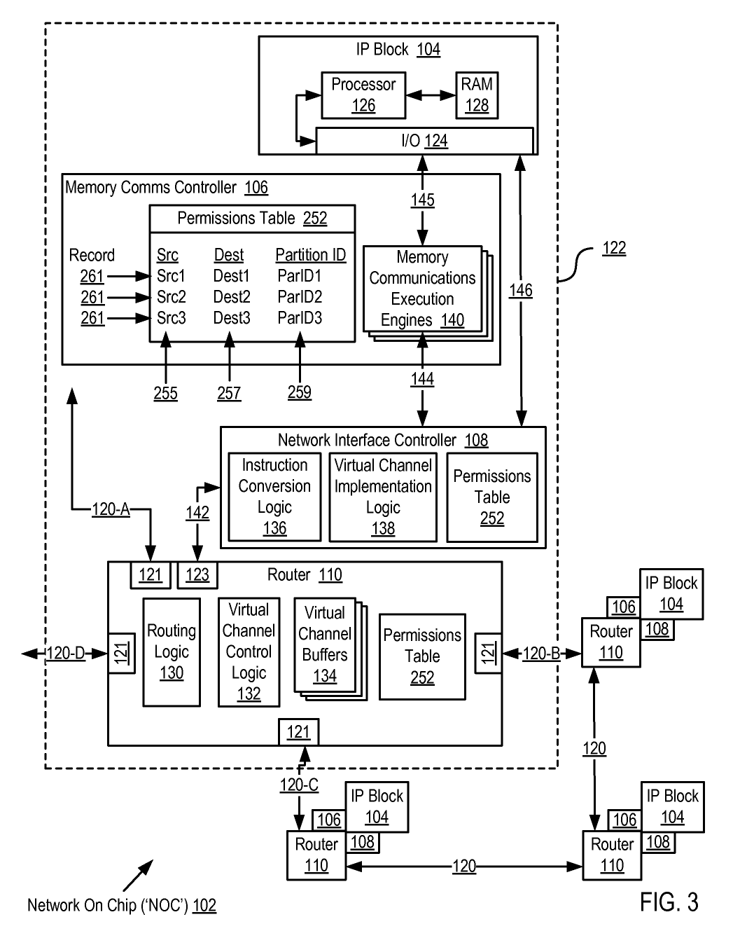

Each IP block (104) in the example of FIG. 2 is adapted to a router (110) through a memory communications controller (106). Each memory communication controller is an aggregation of synchronous and asynchronous logic circuitry adapted to provide data communications between an IP block and memory. Examples of such communications between IP blocks and memory include memory load instructions and memory store instructions. The memory communications controllers (106) are described in more detail below with reference to FIG. 3.

Each IP block (104) in the example of FIG. 2 is also adapted to a router (110) through a network interface controller (108). Each network interface controller (108) controls communications through routers (110) between IP blocks (104). Examples of communications between IP blocks include messages carrying data and instructions for processing the data among IP blocks in parallel applications and in pipelined applications. The network interface controllers (108) are described in more detail below with reference to FIG. 3.

Each IP block (104) in the example of FIG. 2 is adapted to a router (110). The routers (110) and links (120) among the routers implement the network operations of the NOC. The links (120) are packets structures implemented on physical, parallel wire buses connecting all the routers. That is, each link is implemented on a wire bus wide enough to accommodate simultaneously an entire data switching packet, including all header information and payload data. If a packet structure includes 64 bytes, for example, including an eight byte header and 56 bytes of payload data, then the wire bus subtending each link is 64 bytes wise, 512 wires. In addition, each link is bi-directional, so that if the link packet structure includes 64 bytes, the wire bus actually contains 1024 wires between each router and each of its neighbors in the network. A message can includes more than one packet, but each packet fits precisely onto the width of the wire bus. If the connection between the router and each section of wire bus is referred to as a port, then each router includes five ports, one for each of four directions of data transmission on the network and a fifth port for adapting the router to a particular IP block through a memory communications controller and a network interface controller.

Each memory communications controller (106) in the example of FIG. 2 controls communications between an IP block and memory. Memory can include off-chip main RAM (112), memory (115) connected directly to an IP block through a memory communications controller (106), on-chip memory enabled as an IP block (114), and on-chip caches. In the NOC of FIG. 2, either of the on-chip memories (114, 115), for example, may be implemented as on-chip cache memory. All these forms of memory can be disposed in the same address space, physical addresses or virtual addresses, true even for the memory attached directly to an IP block. Memory addressed messages therefore can be entirely bi-directional with respect to IP blocks, because such memory can be addressed directly from any IP block anywhere on the network. Memory (114) on an IP block can be addressed from that IP block or from any other IP block in the NOC. Memory (115) attached directly to a memory communication controller can be addressed by the IP block that is adapted to the network by that memory communication controller—and can also be addressed from any other IP block anywhere in the NOC.

The example NOC includes two memory management units (‘MMUs’) (107, 109), illustrating two alternative memory architectures for NOCs according to embodiments of the present invention. MMU (107) is implemented with an IP block, allowing a processor within the IP block to operate in virtual memory while allowing the entire remaining architecture of the NOC to operate in a physical memory address space. The MMU (109) is implemented off-chip, connected to the NOC through a data communications port (116). The port (116) includes the pins and other interconnections required to conduct signals between the NOC and the MMU, as well as sufficient intelligence to convert message packets from the NOC packet format to the bus format required by the external MMU (109). The external location of the MMU means that all processors in all IP blocks of the NOC can operate in virtual memory address space, with all conversions to physical addresses of the off-chip memory handled by the off-chip MMU (109).

In addition to the two memory architectures illustrated by use of the MMUs (107, 109), data communications port (118) illustrates a third memory architecture useful in NOCs according to embodiments of the present invention. Port (118) provides a direct connection between an IP block (104) of the NOC (102) and off-chip memory (112). With no MMU in the processing path, this architecture provides utilization of a physical address space by all the IP blocks of the NOC. In sharing the address space bi-directionally, all the IP blocks of the NOC can access memory in the address space by memory-addressed messages, including loads and stores, directed through the IP block connected directly to the port (118). The port (118) includes the pins and other interconnections required to conduct signals between the NOC and the off-chip memory (112), as well as sufficient intelligence to convert message packets from the NOC packet format to the bus format required by the off-chip memory (112).

In the example of FIG. 2, one of the IP blocks is designated a host interface processor (105). A host interface processor (105) provides an interface between the NOC and a host computer (152) in which the NOC may be installed and also provides data processing services to the other IP blocks on the NOC, including, for example, receiving and dispatching among the IP blocks of the NOC data processing requests from the host computer. A NOC may, for example, implement a video graphics adapter (209) or a coprocessor (157) on a larger computer (152) as described above with reference to FIG. 1. In the example of FIG. 2, the host interface processor (105) is connected to the larger host computer through a data communications port (115). The port (115) includes the pins and other interconnections required to conduct signals between the NOC and the host computer, as well as sufficient intelligence to convert message packets from the NOC to the bus format required by the host computer (152). In the example of the NOC coprocessor in the computer of FIG. 1, such a port would provide data communications format translation between the link structure of the NOC coprocessor (157) and the protocol required for the front side bus (163) between the NOC coprocessor (157) and the bus adapter (158).

For further explanation, FIG. 3 sets forth a functional block diagram of a further example NOC according to embodiments of the present invention. The example NOC of FIG. 3 is similar to the example NOC of FIG. 2 in that the example NOC of FIG. 3 is implemented on a chip (100 on FIG. 2), and the NOC (102) of FIG. 3 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110). In the example of FIG. 3, one set (122) of an IP block (104) adapted to a router (110) through a memory communications controller (106) and network interface controller (108) is expanded to aid a more detailed explanation of their structure and operations. All the IP blocks, memory communications controllers, network interface controllers, and routers in the example of FIG. 3 are configured in the same manner as the expanded set (122).

In the example of FIG. 3, each IP block (104) includes a computer processor (126) and I/O functionality (124). In this example, computer memory is represented by a segment of random access memory (‘RAM’) (128) in each IP block (104). The memory, as described above with reference to the example of FIG. 2, can occupy segments of a physical address space whose contents on each IP block are addressable and accessible from any IP block in the NOC. The processors (126), I/O capabilities (124), and memory (128) on each IP block effectively implement the IP blocks as generally programmable microcomputers. As explained above, however, in the scope of the present invention, IP blocks generally represent reusable units of synchronous or asynchronous logic used as building blocks for data processing within a NOC. Implementing IP blocks as generally programmable microcomputers, therefore, although a common embodiment useful for purposes of explanation, is not a limitation of the present invention.

In the NOC (102) of FIG. 3, each memory communications controller (106) includes a plurality of memory communications execution engines (140). Each memory communications execution engine (140) is enabled to execute memory communications instructions from an IP block (104), including bi-directional memory communications instruction flow (142, 144, 145) between the network and the IP block (104). The memory communications instructions executed by the memory communications controller may originate, not only from the IP block adapted to a router through a particular memory communications controller, but also from any IP block (104) anywhere in the NOC (102). That is, any IP block in the NOC can generate a memory communications instruction and transmit that memory communications instruction through the routers of the NOC to another memory communications controller associated with another IP block for execution of that memory communications instruction. Such memory communications instructions can include, for example, translation lookaside buffer control instructions, cache control instructions, barrier instructions, and memory load and store instructions.

Each memory communications execution engine (140) is enabled to execute a complete memory communications instruction separately and in parallel with other memory communications execution engines. The memory communications execution engines implement a scalable memory transaction processor optimized for concurrent throughput of memory communications instructions. The memory communications controller (106) supports multiple memory communications execution engines (140) all of which run concurrently for simultaneous execution of multiple memory communications instructions. A new memory communications instruction is allocated by the memory communications controller (106) to a memory communications engine (140) and the memory communications execution engines (140) can accept multiple response events simultaneously. In this example, all of the memory communications execution engines (140) are identical. Scaling the number of memory communications instructions that can be handled simultaneously by a memory communications controller (106), therefore, is implemented by scaling the number of memory communications execution engines (140).

In the NOC (102) of FIG. 3, each network interface controller (108) is enabled to convert communications instructions from command format to network packet format for transmission among the IP blocks (104) through routers (110). The communications instructions are formulated in command format by the IP block (104) or by the memory communications controller (106) and provided to the network interface controller (108) in command format. The command format is a native format that conforms to architectural register files of the IP block (104) and the memory communications controller (106). The network packet format is the format required for transmission through routers (110) of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

In the NOC (102) of FIG. 3, each IP block is enabled to send memory-address-based communications to and from memory through the IP block's memory communications controller and then also through its network interface controller to the network. A memory-address-based communications is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communication that are executed with message traffic are passed from the memory communications controller to an associated network interface controller for conversion (136) from command format to packet format and transmission through the network in a message. In converting to packet format, the network interface controller also identifies a network address for the packet in dependence upon the memory address or addresses to be accessed by a memory-address-based communication. Memory address based messages are addressed with memory addresses. Each memory address is mapped by the network interface controllers to a network address, typically the network location of a memory communications controller responsible for some range of physical memory addresses. The network location of a memory communication controller (106) is naturally also the network location of that memory communication controller's associated router (110), network interface controller (108), and IP block (104). The instruction conversion logic (136) within each network interface controller is capable of converting memory addresses to network addresses for purposes of transmitting memory-address-based communications through routers of a NOC.

Upon receiving message traffic from routers (110) of the network, each network interface controller (108) inspects each packet for memory instructions. Each packet containing a memory instruction is handed to the memory communications controller (106) associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

In the NOC (102) of FIG. 3, each IP block (104) is enabled to bypass its memory communications controller (106) and send inter-IP block, network-addressed communications (146) directly to the network through the IP block's network interface controller (108). Network-addressed communications are messages directed by a network address to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through it I/O functions (124) directly to the IP block's network interface controller in command format, then converted to packet format by the network interface controller and transmitted through routers of the NOC to another IP block. Such network-addressed communications (146) are bi-directional, potentially proceeding to and from each IP block of the NOC, depending on their use in any particular application. Each network interface controller, however, is enabled to both send and receive (142) such communications to and from an associated router, and each network interface controller is enabled to both send and receive (146) such communications directly to and from an associated IP block, bypassing an associated memory communications controller (106).

Each network interface controller (108) in the example of FIG. 3 is also enabled to implement virtual channels on the network, characterizing network packets by type. Each network interface controller (108) includes virtual channel implementation logic (138) that classifies each communication instruction by type and records the type of instruction in a field of the network packet format before handing off the instruction in packet form to a router (110) for transmission on the NOC. Examples of communication instruction types include inter-IP block network-address-based messages, request messages, responses to request messages, invalidate messages directed to caches; memory load and store messages; and responses to memory load messages, and so on.

Each router (110) in the example of FIG. 3 includes routing logic (130), virtual channel control logic (132), and virtual channel buffers (134). The routing logic typically is implemented as a network of synchronous and asynchronous logic that implements a data communications protocol stack for data communication in the network formed by the routers (110), links (120), and bus wires among the routers. The routing logic (130) includes the functionality that readers of skill in the art might associate in off-chip networks with routing tables, routing tables in at least some embodiments being considered too slow and cumbersome for use in a NOC. Routing logic implemented as a network of synchronous and asynchronous logic can be configured to make routing decisions as fast as a single clock cycle. The routing logic in this example routes packets by selecting a port for forwarding each packet received in a router. Each packet contains a network address to which the packet is to be routed. Each router in this example includes five ports, four ports (121) connected through bus wires (120-A, 120-B, 120-C, 120-D) to other routers and a fifth port (123) connecting each router to its associated IP block (104) through a network interface controller (108) and a memory communications controller (106).

In describing memory-address-based communications above, each memory address was described as mapped by network interface controllers to a network address, a network location of a memory communications controller. The network location of a memory communication controller (106) is naturally also the network location of that memory communication controller's associated router (110), network interface controller (108), and IP block (104). In inter-IP block, or network-address-based communications, therefore, it is also typical for application-level data processing to view network addresses as location of IP block within the network formed by the routers, links, and bus wires of the NOC. FIG. 2 illustrates that one organization of such a network is a mesh of rows and columns in which each network address can be implemented, for example, as either a unique identifier for each set of associated router, IP block, memory communications controller, and network interface controller of the mesh or x,y coordinates of each such set in the mesh.

In the NOC (102) of FIG. 3, each router (110) implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router (110) in the example of FIG. 3 also includes virtual channel control logic (132) and virtual channel buffers (134). The virtual channel control logic (132) examines each received packet for its assigned communications type and places each packet in an outgoing virtual channel buffer for that communications type for transmission through a port to a neighboring router on the NOC.

Each virtual channel buffer (134) has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer (134) in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller (108). Each network interface controller is configured to, upon receipt of such a signal, refuse to accept, from its associated memory communications controller (106) or from its associated IP block (104), communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped in the architecture of FIG. 3. When a router encounters a situation in which a packet might be dropped in some unreliable protocol such as, for example, the Internet Protocol, the routers in the example of FIG. 3 suspend by their virtual channel buffers (134) and their virtual channel control logic (132) all transmissions of packets in a virtual channel until buffer space is again available, eliminating any need to drop packets. The NOC of FIG. 3, therefore, implements highly reliable network communications protocols with an extremely thin layer of hardware.

In the example NOC (102) of FIG. 3 also the network is organized into partitions where each partition includes at least one IP block (104) and each partition is assigned exclusive access to a separate physical memory address space. All IP blocks of a partition in the example NOC of FIG. 3 are assigned a partition identifier (‘partition ID’) that uniquely identifies for an IP block a particular partition in which the IP block included the IP block as an IP block in that partition. The example NOC also includes one or more permissions tables (252) associating partition IDs (259) with sources (255) and destinations (257) of data communications on the NOC established on the NOC where each record (261) in the permissions tables (252) represents a restriction on data communications on the NOC (102). Sources (255) and destinations in a permissions table (252) may include network addresses of IP blocks, memory addresses, process identifications, processor identifications, and so on as will occur to those of skill in the art.

The example NOC also includes one or more applications executing on one or more of the partitions, including transmitting data communications messages among IP blocks and between IP blocks and memory with each data communications message including a partition ID of a sender of the data communications message. And the NOC (102) of FIG. 3 also includes data communications among the partitions controlled in dependence upon the permissions tables (252) and the partition IDs.

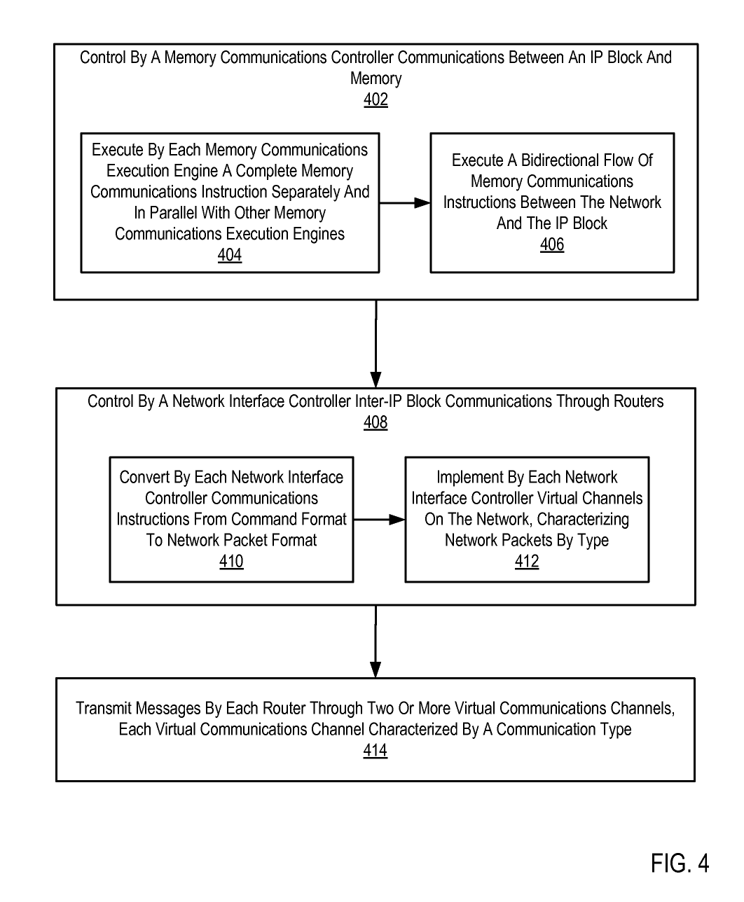

For further explanation, FIG. 4 sets forth a flow chart illustrating an exemplary method for data processing with a NOC according to embodiments of the present invention. The method of FIG. 4 is implemented on a NOC similar to the ones described above in this specification, a NOC (102 on FIG. 3) that is implemented on a chip (100 on FIG. 3) with IP blocks (104 on FIG. 3), routers (110 on FIG. 3), memory communications controllers (106 on FIG. 3), and network interface controllers (108 on FIG. 3). Each IP block (104 on FIG. 3) is adapted to a router (110 on FIG. 3) through a memory communications controller (106 on FIG. 3) and a network interface controller (108 on FIG. 3). In addition, the example NOC (102 on FIG. 3) also includes the network organized into partitions where each partition includes at least one IP block (104 on FIG. 3) and each partition is assigned exclusive access to a separate physical memory address space. All IP blocks of a partition in the NOC (102 on FIG. 3) are assigned a partition identifier (‘partition ID’) that uniquely identifies for an IP block a particular partition in which the IP block is included. The example NOC also includes one or more permissions tables (252 on FIG. 3) associating partition IDs with sources and destinations of data communications on the NOC (102 on FIG. 3) established on the NOC where each record in the permissions tables represents a restriction on data communications on the NOC. The NOC (102 on FIG. 3) may also include one or more applications executing on one or more of the partitions, including transmitting data communications messages among IP blocks and between IP blocks and memory with each data communications message including a partition ID of a sender of the data communications message. In such a NOC (102 on FIG. 3), data communications among the partitions may be controlled in dependence upon the permissions tables and the partition IDs. In the method of FIG. 4, each IP block may be implemented as a reusable unit of synchronous or asynchronous logic design used as a building block for data processing within the NOC.

The method of FIG. 4 includes controlling (402) by a memory communications controller (106 on FIG. 3) communications between an IP block and memory. In the method of FIG. 4, the memory communications controller includes a plurality of memory communications execution engines (140 on FIG. 3). Also in the method of FIG. 4, controlling (402) communications between an IP block and memory is carried out by executing (404) by each memory communications execution engine a complete memory communications instruction separately and in parallel with other memory communications execution engines and executing (406) a bi-directional flow of memory communications instructions between the network and the IP block. In the method of FIG. 4, memory communications instructions may include translation lookaside buffer control instructions, cache control instructions, barrier instructions, memory load instructions, and memory store instructions. In the method of FIG. 4, memory may include off-chip main RAM, memory connected directly to an IP block through a memory communications controller, on-chip memory enabled as an IP block, and on-chip caches.

The method of FIG. 4 also includes controlling (408) by a network interface controller (108 on FIG. 3) inter-IP block communications through routers. In the method of FIG. 4, controlling (408) inter-IP block communications also includes converting (410) by each network interface controller communications instructions from command format to network packet format and implementing (412) by each network interface controller virtual channels on the network, including characterizing network packets by type.

The method of FIG. 4 also includes transmitting (414) messages by each router (110 on FIG. 3) through two or more virtual communications channels, where each virtual communications channel is characterized by a communication type. Communication instruction types, and therefore virtual channel types, include, for example: inter-IP block network-address-based messages, request messages, responses to request messages, invalidate messages directed to caches; memory load and store messages; and responses to memory load messages, and so on. In support of virtual channels, each router also includes virtual channel control logic (132 on FIG. 3) and virtual channel buffers (134 on FIG. 3). The virtual channel control logic examines each received packet for its assigned communications type and places each packet in an outgoing virtual channel buffer for that communications type for transmission through a port to a neighboring router on the NOC.

For ease of explanation, the example NOC of FIG. 2 is illustrated with sixteen sets of IP blocks adapted to routers through memory communications controllers and network interface controllers. Similarly, the example NOC of FIG. 3 is illustrated with four sets of IP blocks adapted to routers through memory communications controllers and network interface controllers. Readers will recognize, however, that practical NOCs implemented according to embodiments of the present invention will often include hundreds or thousands of sets of IP blocks adapted to routers through memory communications controllers and network interface controllers. Such NOCs may support the operation of many application programs simultaneously, therefore benefiting from partitioning of the resources on the NOC.

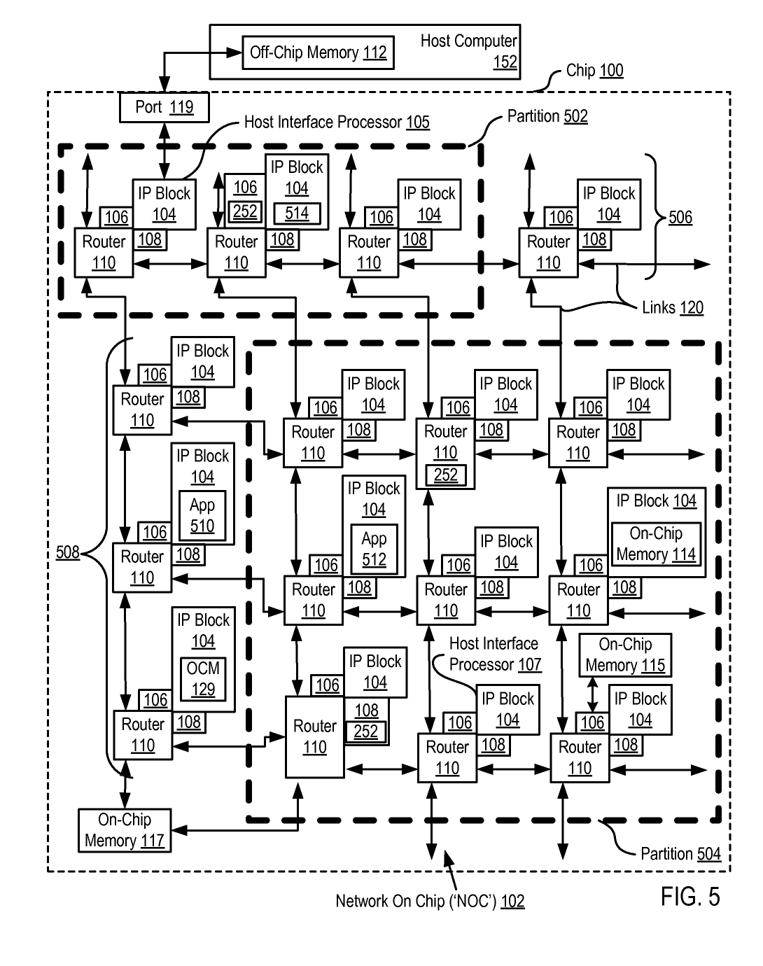

For further explanation, FIG. 5 sets forth a functional block diagram of a further example NOC according to embodiments of the present invention. The example NOC of FIG. 5 is similar to the example NOC of FIG. 2 in that the example NOC of FIG. 5 is implemented on a chip (100), and the NOC (102) of FIG. 5 includes IP blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110).

In the example of FIG. 5, the network (102) is organized into partitions (502, 504). Partition (502) includes a host interface processor (105) and partition (504) includes a separate host interface processor (107). Each partition (502, 504) also includes at least one IP block (104), and each partition is assigned exclusive access to a separate physical memory address space. Partition (502), for example, along with all IP blocks (104) in partition (502), is assigned exclusive access to a separate physical memory address space disposed upon off-chip memory (112) in a host computer (152) accessed through port (119). Similarly, partition (504), including all the IP blocks in partition (504), is assigned exclusive access to a separate physical memory address space disposed upon on-chip memory (114, 115).

In the NOC of FIG. 5, partition (502) is an example of a partition formed by assignment of exclusive access to a separate physical memory address space embodied in off-chip memory (112) on a host computer (152), where IP blocks (104) in partition (502) access the off-chip memory (112) through port (119). The port (119) includes the pins and other interconnections required to conduct signals between the NOC (102) and the off-chip memory (112), as well as sufficient intelligence to convert message packets from the NOC packet format to the bus format required by the off-chip memory (112).

Routers in a partition in accordance with embodiments of the present invention may or may not be adjacent to one another. In the example NOC of FIG. 5, routers in partition (502) are adjacent to one another and routers in partition (504) are also adjacent to one another. The set (506) of IP block, router, memory communication controller and network interface controller plus the sets (508) of IP blocks, routers, memory communication controllers, and network interface controllers, however, form such a partition with routers that are not all adjacent to one another within the network. In the NOC of FIG. 5, the routers in sets (508) are all adjacent to one another within the architecture of the network, but the router in set (506) is adjacent to none of the routers in sets (508).

In the NOC of FIG. 5, all IP blocks (104) of a partition are assigned a partition identifier (‘partition ID’). A partition identifier for an IP block uniquely identifies a particular partition for which the IP block is included. Assigning all IP blocks of a partition a partition identifier may be carried out by storing in memory accessible by each IP block associations of identifications of IP blocks, such as network addresses of IP blocks, and partition IDs. Assignments of partition IDs to IP blocks may be restricted, typically for security purposes, to configuration only by processes with NOC-level privileges. NOC-level privileges, by analogy, are to a NOC what super-user privileges are to an operating system. That is, NOC-level privileges are chip-wide privileges authorizing a particular process to configure the NOC. Typical super-users in an operating system executing on a partition in a NOC in accordance with embodiments of the present invention may not be granted NOC-level privileges as many different operating systems, each having its own set of super-users, may be executing on separate partitions on the same NOC.

In the NOC of FIG. 5, one or more permissions tables (252) associating partition IDs with sources and destinations of data communications on the NOC are established. Each record in the permissions tables (252) represents a restriction on data communications on the NOC. Establishing one or more permissions tables (252) associating partition IDs with sources and destinations of data communications on the NOC (102) may be carried out in one or more of the following ways: establishing a permissions table in a network interface controller (108) associated with a particular IP block, establishing a permissions table (252) in a router (110), and establishing a permissions table in a memory controller (106). Permissions tables (252), for example, may be implemented in architectural registers of a network interface controller, router, or memory controller. In the example of FIG. 5, a permissions table (252) is established in only one router, in only one network interface controller, and in only one memory controller for clarity. Readers of skill in the art will immediately recognize, however, that permissions tables in accordance with embodiments of the present invention may be established in many routers, many network interface controllers, and many memory controllers on a NOC. In fact, in typical embodiments of the present invention, a permissions table will be established in every router, every network interface controller, or every memory controller on the NOC. Moreover, permissions tables may be established in any combination of router, network interface controller (108) and memory controller. Permissions tables may be established, for example, in every router, every network interface controller (108) and every memory controller on the entire NOC.

In some embodiments of the present invention, the routers (110) of the NOC of FIG. 5 implement two or more virtual communications channels where each virtual communications channel is characterized by a communication type. In such an embodiment, each record in the permissions tables may additionally represent a restriction on data communications by virtual communications channel. IP blocks in partition (504), for example, may only transmit data communications messages on virtual communications channel 1, while IP blocks in partition (502) may only transmit data communications messages on virtual communications channel 2.

In addition to restricting configuration of partition ID assignments to processes with NOC-level privileges, so also configuration of the permissions tables may be restricted to configuration by only processes with NOC-level privileges. Such a process with NOC-level privileges may be a module of computer program instructions executing on an IP block on the NOC dedicated to executing processes with NOC-level privileges, a module of computer program instructions executing on a host computer (152) connected to the NOC through a port (119), or a module of computer program instructions executing on any IP block (104) on the NOC (102) where data communications from the IP block (104) include an identification of the process as a process with NOC-level privileges, through use of a process ID or token for example.

In the NOC of FIG. 5, one or more applications are executing on one or more of the partitions. Application (512) executes on an IP block (104) in partition (504). Application (514) executes on an IP block (104) in partition (502). Applications in this context are application programs, modules of user-level computer program instructions for carrying out particular data processing tasks such as tasks used, for example, for video gaming, stock market simulations, atomic quantum process simulations, or other user-level applications. Applications executing on one or more of the partitions in the NOC of FIG. 5, transmit data communications messages among IP blocks and between IP blocks and memory. Each data communications message includes a partition ID of a sender of the data communications message. Such a partition ID may be inserted, by a network interface controller, in a message header of the data communications message or inserted, by the originating module of computer program instructions executing on a processor of the sending IP block, as part of the payload data of the message itself.

In the NOC of FIG. 5, data communications among the partitions are controlled in dependence upon the permissions tables (252) and the partition IDs. When a permissions table (252) is established in a network interface controller (108) associated with a particular IP block, controlling data communications among the partitions in dependence upon the permissions tables (252) and the partition IDs may include restricting, by the network interface controller, data communications originating from the particular IP block to one or more IP blocks in restricted partitions or restricting data communications to the particular IP block originating from one or more IP blocks in restricted partitions. Restricting data communications originating from the particular IP block to one or more IP blocks in restricted partitions may be carried out by determining the partition ID of the destination IP block of a data communications message originating form the particular IP block, determining from the permissions table (252) whether the partition ID of the destination IP block is a partition ID of a restricted partition; if the partition ID of the destination IP block is a partition ID of a restricted partition, dropping the data communications message; and if the partition ID of the destination IP block is not a partition ID of a restricted partition, sending the data communications message along. A data communications message originating from a particular IP block in partition (502), for example, may be restricted by a network interface controller associated with the particular IP block from transmission to any IP block in partition (504), a restricted partition with respect to partition (502).

Restricting data communications to the particular IP block originating from one or more IP blocks in restricted partitions may be carried out by determining from the permissions table (252) whether the partition ID of the source IP block is a partition ID in a restricted partition; if the partition ID of the source IP block is a partition ID in a restriction partition, dropping the data communications message; and if the partition ID of the source IP block is not a partition ID in a restriction partition; processing the data communications message. A data communications message originating from a particular IP block in partition (502), for example, may be dropped by a network interface controller associated with a destination IP block in partition (504), a restricted partition with respect to partition (502).

When one or more permissions tables (252) are established in a router (110), controlling data communications among the partitions in dependence upon the permissions tables (252) and the partition IDs may include restricting, by the router, transmission of data communications through ports of the router. In the NOC of FIG. 5, for example, a data communications message originating from an IP block in partition (502) entering a router (110) in partition (504) may be restricted to transmission through only particular ports of the router, including the port connected to the router's associated IP block, or through no port at all.

When permissions tables (252) are established in a memory controller, controlling data communications among the partitions in dependence upon the permissions tables (252) and the partition IDs may include restricting, by the memory controller, all memory access through the memory controller by one or more IP blocks in restricted partitions. Restricting all memory access through the memory controller may include restricting access by a memory controller when that memory controller is a destination of a data communications message or by a memory controller when that memory controller is associated with the source IP block of the data communications message. Restricting, by the memory controller, all memory access through the memory controller by one or more IP blocks in restricted partitions may be carried out, when the memory controller is the destination of a memory-addressed-message, by determining from the permission table (252) whether the partition ID of the source of the memory-addressed-message is a partition ID of a restricted partition; if the partition ID of the source is partition ID of a restricted partition, dropping the memory-addressed-message; and if the partition ID of the source is not a partition ID of a restricted partition, processing the memory-addressed-message, that is, executing memory instructions included in the memory-addressed-message. Restricting, by the memory controller, all memory access through the memory controller by one or more IP blocks in restricted partitions may be carried out, when a memory-addressed-message originates from an IP block associated with the memory controller, by determining the partition ID of the destination of the memory-addressed-message; determining from the permissions table (252) whether that partition ID is an ID of a restricted partition; if the partition ID is an ID of a restricted partition dropping the memory-addressed-message; and if the partition ID is not an ID of a restricted partition, forwarding the memory-addressed-message along.

In the NOC of FIG. 5, for example, consider that partition (502) is a restricted partition with respect to partition (504) and vice versa. Controlling data communications, originating from an IP block in partition (502), may include restricting, by a ‘destination’ memory controller (106) in partition (504), all memory access to on-chip memory (114) through the memory controller. That is, no IP block in partition (502) may access the on-chip memory (114) in partition (504). The same memory controller (106) in partition (504) may also restrict memory-addressed-messages originating form an associated IP block (104) when the destination of the memory-addressed-message is a memory controller in partition (502).

In addition, when a permissions table (252) is established in a memory controller, controlling data communications among the partitions in dependence upon the permissions tables (252) and the partition IDs may also include restricting, by the memory controller, access to a range of memory addresses by one or more IP blocks in restricted partitions. Restricting, by the memory controller, access to a range of memory addresses by one or more IP blocks in restricted partitions may be carried out by determining from the permissions table (252) that partition ID of the source of a memory-addressed-message is a partition ID of a restricted partition; determining whether the memory address of the memory-addressed-message is included in a range of memory addresses accessible by IP blocks in the restricted partition; if the memory address is included in a range of memory addresses accessible by IP blocks in the restricted partition, processing the memory-addressed message; and if the memory address is not included in a range of memory addresses accessible by IP blocks in the restricted partition, dropping the memory-addressed message.

Restricting access to a range of memory addresses enables partitions in the NOC to share a segment of physical memory address space. In the NOC of FIG. 5, for example, partition (504) may be assigned exclusive access to separate physical memory (114, 115) and also share a segment of physical memory address space in on-chip memory (117) with the partition (506,508). Similarly, partition (506, 508) may be assigned exclusive access to separate physical on-chip memory (129) and also share a segment of physical memory address space in on-chip memory (117) with partition (504). In terms an overall physical memory address space for the NOC (102) represented, for example, in hexadecimal addresses as the 4 GB space from 00000000 to FFFFFFFF, partition (506, 508) may be assigned exclusive access to the address space from 00000000 to CFFFFFFF, partition (504) may be assigned exclusive access to the address space from E0000000 to FFFFFFFF, and both partitions may be assigned non-exclusive access to the address space from D0000000 to DFFFFFFF, so that the two partitions share the segment of physical memory address space from D0000000 to DFFFFFFF. Such sharing of memory facilitates, for example, communications between the partitions with memory variables instantiated separately in the two partitions and addressing the same physical memory, access to which is coordinated with semaphores, for example.

In the NOC of FIG. 5, the one or more applications (510, 512, 514) executing on one or more of the partitions may be implemented with at least one of the applications pipelined in stages. A pipeline is a set of modules of computer program instructions that cooperate with one another to carry out a series of data processing tasks in sequence. Each stage in a pipeline is composed of a flexibly configurable module of computer program instructions identified by a stage 1D with each stage executing on a thread of execution on an IP block in a same partition. The stages are ‘flexibly configurable’ in that each stage may support multiple instances of the stage, so that a pipeline may be scaled by instantiating additional instances of a stage as needed depending on workload.

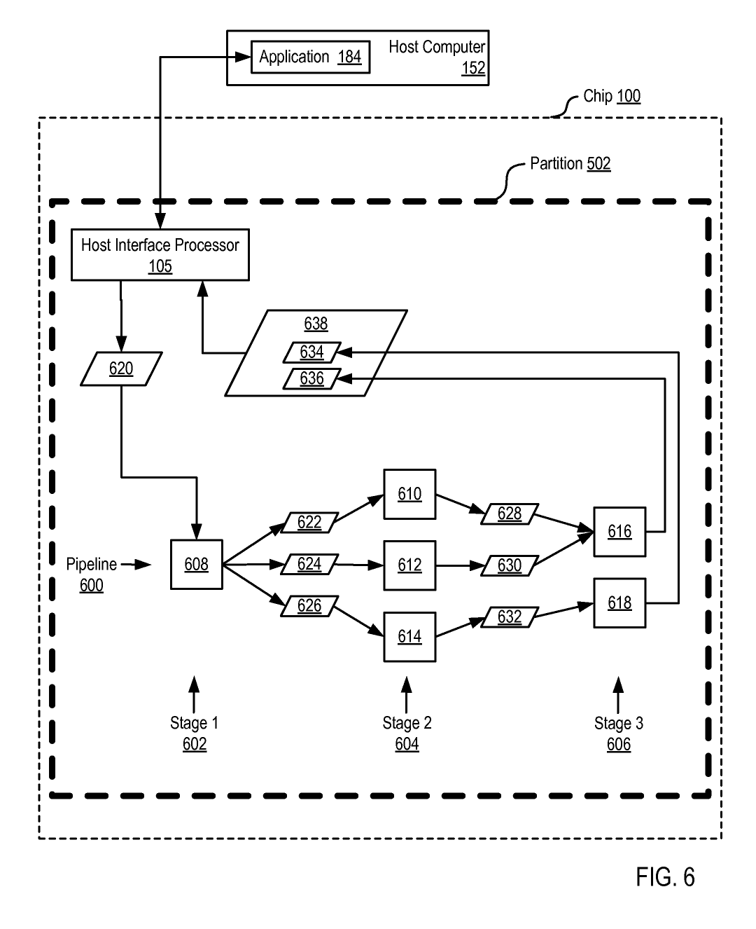

For further explanation, FIG. 6 sets forth a data flow diagram illustrating operation of an example pipeline (600). The example pipeline (600) of FIG. 6 includes three stages (602, 604, 606) of execution. Stage 1 receives work instructions and work piece data (620) through a host interface processor (105) from an application (184) running on a host computer (152). Stage 1 carries out its designated data processing tasks on the work piece and passes the results (622, 624, 626) to stage 2, which carries out its designated data processing tasks on the results from stage 1 and passes its results (628, 630, 632) to stage 3, which carries out its designated data processing tasks on the results from stage 2 and stores its results (634, 636) in an output data structure (638) for eventual return through the host interface processor (105) to the originating application program (184) on the host computer (152). The return to the originating application program is said to be ‘eventual’ because quite a lot of return data may need to be calculated before the output data structure (638) is ready to return. The pipeline (600) in this example is represented with only six instances (622-632) in three stages (602-606). Many pipelines according to embodiments of the present invention, however, may includes many stages and many instances of stages. In an atomic process modeling application, for example, the output data structure (638) may represent the state at a particular nanosecond of an atomic process containing the exact quantum state of billions of sub-atomic particles, each of which requires thousands of calculations in various stages of a pipeline. Or in a video processing application, for a further example, the output data structure (638) may represent a video frame composed of the current display state of thousands of pixels, each of which requires many calculations in various stages of a pipeline.

Each instance (622-632) of each stage (602-606) of the pipeline (600) is implemented as an application-level module of computer program instructions executed on a separate IP block (104 on FIG. 5) in a partition (502) of a NOC (102 on FIG. 5). The pipeline (600) is implemented in this example with one instance (608) of stage 1, three instances (610, 612, 614) of stage 2, and two instances (616, 618) of stage 3. Stage 1 (602, 608) is configured at start-up by the host interface processor (105) with the number of instances of stage 2 and the network location of each instance of stage 2. Stage 1 (602, 608) may distribute its resultant workload (622, 624, 626) by, for example, distributing it equally among the instances (610-614) of stage 2. Each instance (610-614) of stage 2 is configured at start up with the network location of each instance of stage 3 to which an instance of stage 2 is authorized to send its resultant workload. In this example, instances (610, 612) are both configured to send their resultant workloads (628, 630) to instance (616) of stage 3, whereas only one instance (614) of stage 2 sends work (632) to instance (618) of stage 3. If instance (616) becomes a bottleneck trying to do twice the workload of instance (618), an additional instance of stage 3 may be instantiated, even in real time at run time if needed.

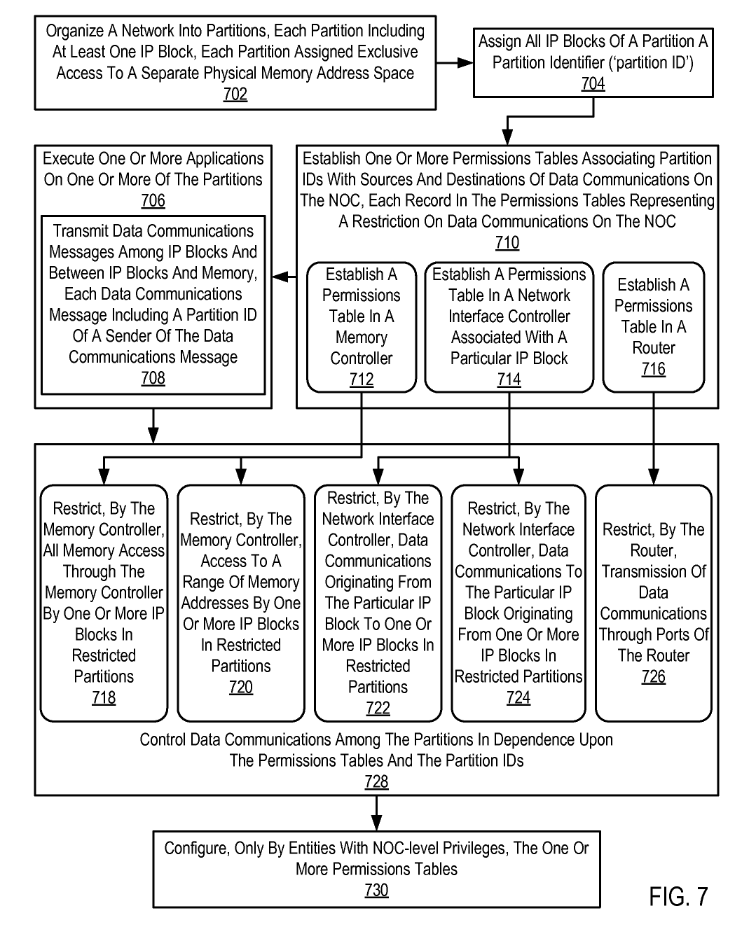

For further explanation, FIG. 7 sets forth a flow chart illustrating an exemplary method for data processing with a NOC according to embodiments of the present invention. The method of FIG. 7 is implemented on a NOC similar to the ones described above in this specification, a NOC (102 on FIG. 5) that is implemented on a chip (100 on FIG. 5) with IP blocks (104 on FIG. 5), routers (110 on FIG. 5), memory communications controllers (106 on FIG. 5), and network interface controllers (108 on FIG. 5). Each IP block (104 on FIG. 5) is adapted to a router (110 on FIG. 5) through a memory communications controller (106 on FIG. 5) and a network interface controller (108 on FIG. 5). In the method of FIG. 7, each IP block is implemented as a reusable unit of synchronous or asynchronous logic design used as a building block for data processing within the NOC.

The method of FIG. 7 includes organizing (702) the network into partitions, each partition including at least one IP block, each partition assigned exclusive access to a separate physical memory address space. In addition in the method of FIG. 7, two or more partitions also may share a segment of physical memory address space.

The method of FIG. 7 also includes assigning (704) all IP blocks of a partition a partition identifier (‘partition ID’). IN the method of FIG. 7, a partition ID uniquely identifies for an IP block a particular partition in which the IP block is included.

The method of FIG. 7 also includes establishing (710) one or more permissions tables associating partition IDs with sources and destinations of data communications on the NOC. In the method of FIG. 7, each record in the permissions tables represents a restriction on data communications on the NOC. The method of FIG. 7 also includes configuring (730), only by processes with NOC-level privileges, the one or more permissions tables.

In the method of FIG. 7, establishing (710) one or more permissions tables associating partition IDs with sources and destinations of data communications on the NOC may be carried out by establishing (714) a permissions table in a network interface controller associated with a particular IP block. In the method of FIG. 7, establishing (710) one or more permissions tables associating partition IDs with sources and destinations of data communications on the NOC may also be carried out by establishing (716) a permissions table in a router. In the method of FIG. 7, establishing (710) one or more permissions tables associating partition IDs with sources and destinations of data communications on the NOC may also be carried out by establishing (712) a permissions table in a memory controller.

The method of FIG. 7 also includes executing (706) one or more applications on one or more of the partitions. In the method of FIG. 7, executing (706) one or more applications on one or more of the partitions includes transmitting (708) data communications messages among IP blocks and between IP blocks and memory. Also in the method of FIG. 7, each data communications message includes a partition ID of a sender of the data communications message.

The method of FIG. 7 also includes controlling (728) data communications among the partitions in dependence upon the permissions tables and the partition IDs. When establishing (710) one or more permissions tables associating partition IDs with sources and destinations of data communications on the NOC is carried out by establishing (716) a permissions table in a router, controlling (728) data communications among the partitions in dependence upon the permissions tables and the partition IDs may include restricting (726), by the router, transmission of data communications through ports of the router.

When establishing (710) one or more permissions tables associating partition IDs with sources and destinations of data communications on the NOC is carried out by establishing (712) a permissions table in a memory controller, controlling (728) data communications among the partitions in dependence upon the permissions tables and the partition IDs may include restricting (718), by the memory controller, all memory access through the memory controller by one or more IP blocks in restricted partitions. In addition, when establishing (710) one or more permissions tables associating partition IDs with sources and destinations of data communications on the NOC is carried out by establishing (712) a permissions table in a memory controller, controlling (728) data communications among the partitions in dependence upon the permissions tables and the partition IDs may include restricting (720), by the memory controller, access to a range of memory addresses by one or more IP blocks in restricted partitions.

When establishing (710) one or more permissions tables associating partition IDs with sources and destinations of data communications on the NOC is carried out by establishing (714) a permissions table in a network interface controller associated with a particular IP block, controlling (728) data communications among the partitions in dependence upon the permissions tables and the partition IDs may include restricting (722), by the network interface controller, data communications originating from the particular IP block to one or more IP blocks in restricted partitions. In addition, when establishing (710) one or more permissions tables associating partition IDs with sources and destinations of data communications on the NOC is carried out by establishing (714) a permissions table in a network interface controller associated with a particular IP block, controlling (728) data communications among the partitions in dependence upon the permissions tables and the partition IDs may include restricting (724), restricting, by the network interface controller, data communications to the particular IP block originating from one or more IP blocks in restricted partitions.

In a NOC on which the method of FIG. 7 is implemented, each router may implement two or more virtual communications channels with each virtual communications channel characterized by a communication type and each record in the permissions tables also including a representation of a restriction on data communications by virtual channel.

Exemplary embodiments of the present invention are described largely in the context of a fully functional computer system for data processing with a NOC. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of data processing with a network on chip (‘NOC’), the NOC comprising integrated processor (‘IP’) blocks, routers, memory communications controllers, and network interface controller, each IP block adapted to a router through a memory communications controller and a network interface controller, each memory communications controller controlling communication between an IP block and memory, and each network interface controller controlling inter-IP block communications through routers, the method comprising:
organizing the network into partitions, each partition including at least one IP block, each partition assigned exclusive access to a separate physical memory address space;
assigning all IP blocks of a partition a partition identifier (‘partition ID’) that uniquely identifies for an IP block a particular partition in which the IP block is included;
establishing one or more permissions tables associating partition IDs with sources and destinations of data communications on the NOC, each record in the permissions tables representing a restriction on data communications on the NOC;
executing one or more applications on one or more of the partitions, including transmitting data communications messages among IP blocks and between IP blocks and memory, each data communications message including a partition ID of a sender of the data communications message; and controlling data communications among the partitions in dependence upon the permissions tables and the partition IDs.

2. The method of claim 1 wherein:
establishing one or more permissions tables associating partition IDs with sources and destinations of data communications on the NOC further comprises establishing a permissions table in a network interface controller associated with a particular IP block; and
controlling data communications among the partitions in dependence upon the permissions tables and the partition IDs further comprises restricting, by the network interface controller, data communications originating from the particular IP block to one or more IP blocks in restricted partitions.

3. The method of claim 1 wherein:
establishing one or more permissions tables associating partition IDs with sources and destinations of data communications on the NOC further comprises establishing a permissions table in a network interface controller associated with a particular IP block; and
controlling data communications among the partitions in dependence upon the permissions tables and the partition IDs further comprises restricting, by the network interface controller, data communications to the particular IP block originating from one or more IP blocks in restricted partitions.

4. The method of claim 1 wherein:
establishing one or more permissions tables associating partition IDs with sources and destinations of data communications on the NOC further comprises establishing a permissions table in a router; and
controlling data communications among the partitions in dependence upon the permissions tables and the partition IDs further comprises restricting, by the router, transmission of data communications through ports of the router.

5. The method of claim 1 wherein:
establishing one or more permissions tables associating partition IDs with sources and destinations of data communications on the NOC further comprises establishing a permissions table in a memory controller; and
controlling data communications among the partitions in dependence upon the permissions tables and the partition IDs further comprises restricting, by the memory controller, all memory access through the memory controller by one or more IP blocks in restricted partitions.

6. The method of claim 1 wherein:
establishing one or more permissions tables associating partition IDs with sources and destinations of data communications on the NOC further comprises establishing a permissions table in a memory controller; and
controlling data communications among the partitions in dependence upon the permissions tables and the partition IDs further comprises restricting, by the memory controller, access to a range of memory addresses by one or more IP blocks in restricted partitions.

7. The method of claim 1 wherein each router implements two or more virtual communications channels, each virtual communications channel characterized by a communication type, and each record in the permissions tables further comprises a representation of a restriction on data communications by virtual communications channel.

8. The method of claim 1 further comprises configuring, only by processes with NOC-level privileges, the one or more permissions tables.

9. A network on chip (‘NOC’), the NOC comprising:
integrated processor (‘IP’) blocks, routers, memory communications controllers, and network interface controller, each IP block adapted to a router through a memory communications controller and a network interface controller, each memory communications controller controlling communication between an IP block and memory, and each network interface controller controlling inter-IP block communications through routers;
the network organized into partitions, each partition including at least one IP block, each partition assigned exclusive access to a separate physical memory address space;
all IP blocks of a partition assigned a partition identifier (‘partition ID’) that uniquely identifies for an IP block a particular partition in which the IP block is included;
one or more permissions tables associating partition IDs with sources and destinations of data communications on the NOC established on the NOC, each record in the permissions tables representing a restriction on data communications on the NOC;
one or more applications executing on one or more of the partitions, including transmitting data communications messages among IP blocks and between IP blocks and memory, each data communications message including a partition ID of a sender of the data communications message; and
data communications among the partitions controlled in dependence upon the permissions tables and the partition IDs.

10. The NOC of claim 9 wherein:
one or more permissions tables associating partition IDs with sources and destinations of data communications on the NOC established on the NOC further comprises a permissions table established in a network interface controller associated with a particular IP block; and
data communications among the partitions controlled in dependence upon the permissions tables and the partition IDs further comprise data communications to one or more IP blocks in restricted partitions originating from the particular IP block restricted by the network interface controller.

11. The NOC of claim 9 wherein:
one or more permissions tables associating partition IDs with sources and destinations of data communications on the NOC established on the NOC further comprises a permissions table established in a network interface controller associated with a particular IP block; and
data communications among the partitions controlled in dependence upon the permissions tables and the partition IDs further comprise data communications to the particular IP block originating from one or more IP blocks in restricted partitions restricted by the network interface controller.

12. The NOC of claim 9 wherein:
one or more permissions tables associating partition IDs with sources and destinations of data communications on the NOC established on the NOC further comprises a permissions table established in a router; and
data communications among the partitions controlled in dependence upon the permissions tables and the partition IDs further comprise transmission of data communications through ports of the router restricted by the router.

13. The NOC of claim 9 wherein:
one or more permissions tables associating partition IDs with sources and destinations of data communications on the NOC established on the NOC further comprises a permissions table established in a memory controller; and
data communications among the partitions controlled in dependence upon the permissions tables and the partition IDs further comprise all memory access through the memory controller by one or more IP blocks in restricted partitions restricted by the memory controller.

14. The NOC of claim 9 wherein:
one or more permissions tables associating partition IDs with sources and destinations of data communications on the NOC established on the NOC further comprises a permissions table established in a memory controller; and
data communications among the partitions controlled in dependence upon the permissions tables and the partition IDs further comprises access to a range of memory addresses, by one or more IP blocks in restricted partitions, restricted by the memory controller.

15. The NOC of claim 9 wherein each router implements two or more virtual communications channels, each virtual communications channel characterized by a communication type, and each record in the permissions tables further comprises a representation of a restriction on data communications by virtual communications channel.

16. The NOC of claim 9 further comprising the one or more permissions tables configured only by processes with NOC-level privileges.

17. A computer program product for data processing with a network on chip (‘NOC’), the NOC comprising integrated processor (‘IP’) blocks, routers, memory communications controllers, and network interface controller, each IP block adapted to a router through a memory communications controller and a network interface controller, each memory communications controller controlling communication between an IP block and memory, and each network interface controller controlling inter-IP block communications through routers, the computer program product disposed in a computer readable medium, the computer program product comprising computer program instructions capable of:
organizing the network into partitions, each partition including at least one IP block, each partition assigned exclusive access to a separate physical memory address space;
assigning all IP blocks of a partition a partition identifier (‘partition ID’) that uniquely identifies for an IP block a particular partition in which the IP block is included;
establishing one or more permissions tables associating partition IDs with sources and destinations of data communications on the NOC, each record in the permissions tables representing a restriction on data communications on the NOC;
executing one or more applications on one or more of the partitions, including transmitting data communications messages among IP blocks and between IP blocks and memory, each data communications message including a partition ID of a sender of the data communications message; and
controlling data communications among the partitions in dependence upon the permissions tables and the partition IDs.

18. The computer program product of claim 17 wherein:
establishing one or more permissions tables associating partition IDs with sources and destinations of data communications on the NOC further comprises establishing a permissions table in a network interface controller associated with a particular IP block; and
controlling data communications among the partitions in dependence upon the permissions tables and the partition IDs further comprises restricting, by the network interface controller, data communications originating from the particular IP block to one or more IP blocks in restricted partitions.

19. The computer program product of claim 17 wherein:
establishing one or more permissions tables associating partition IDs with sources and destinations of data communications on the NOC further comprises establishing a permissions table in a router; and
controlling data communications among the partitions in dependence upon the permissions tables and the partition IDs further comprises restricting, by the router, transmission of data communications through ports of the router.

20. The computer program product of claim 17 wherein:
establishing one or more permissions tables associating partition IDs with sources and destinations of data communications on the NOC further comprises establishing a permissions table in a memory controller; and
controlling data communications among the partitions in dependence upon the permissions tables and the partition IDs further comprises restricting, by the memory controller, access to a range of memory addresses by one or more IP blocks in restricted partitions.
